(19) United States
(12) Patent Application Publication
(10) Pub. No.: US 2021/0379942 A1
(43) Pub. Date: Dec. 9, 2021

(54) Stabilizing Apparatus and Method

(71) Applicant: Ronald Reese, DeSoto, TX (US)

(72) Inventor: Ronald Reese, DeSoto, TX (US)

(21) Appl. No.: 16/894,835

(22) Filed: Jun. 7, 2020

(51) Int. Cl. B60D 1/06; B60D 1/44; B60D 1/52

(52) U.S. Cl. CPC B60D 1/065; B60D 1/52; B60D 1/44

(57) ABSTRACT

A hitch stabilizer having a base having a base head section. The base head section having a base head area. The hitch stabilizer having a base body section and a base foot section. The base foot section having a base foot area. A ball joint coupled to the base head section and a track tie down coupled to the base body section.

### BACKGROUND

Countless number of individuals travel the roads and highways each day in cars and trucks. Many of those individuals tow trailers that carries items for recreational or business purposes. Safety is paramount, especially if travelers are towing valuable or dangerous material. For example, many enthusiasts tow motorcycles, All-Terrain Vehicles (ATV), or other similar mobile unit. The enthusiast must be careful to avoid sudden shifts in momentum caused by unsafe road conditions. Sudden changes in momentum could cause the mobile unit to quickly project forward or backwards resulting in damage or personal injury. Standard ratchet straps do not provide the necessary stability to hold a mobile apparatus from shifting and limits access to enclosed trailers when in use. Securing a mobile apparatus to a trailer or hauler such that the mobile unit does not shift forward or backwards is a challenge.

### BRIEF DESCRIPTION OF THE DRAWINGS

FIG. 1A is a perspective view of a hitch stabilizer.

FIG. 1B is a front perspective view of a hitch stabilizer.

FIG. 1C is a perspective view of a hitch stabilizer having two track tie downs.

FIG. 2 is an exploded view of a hitch stabilizer having a pyramidal base.

FIG. 3 is a perspective view of a trailer coupler and a hitch stabilizer coupled to a track rail.

FIG. 4 is an aerial perspective view of a mobile unit, hitch stabilizer, and a track rail coupled to a bed of a trailer.

FIG. 5 is a flow chart of the method of coupling a mobile unit to a trailer using a hitch stabilizer.

### DETAILED DESCRIPTION

The following detailed description illustrates embodiments of the present disclosure. These embodiments are described in sufficient detail to enable a person of ordinary skill in the art to practice these embodiments without undue experimentation. It should be understood, however, that the embodiments and examples described herein are given by way of illustration only, and not by way of limitation. Various substitutions, modifications, additions, and rearrangements may be made that remain potential applications of the disclosed techniques. Therefore, the description that follows is not to be taken as limiting on the scope of the appended claims. In particular, an element associated with a particular embodiment should not be limited to association with that particular embodiment but should be assumed to be capable of association with any embodiment discussed herein.

There are many individuals who travel the roads and highways each day in cars and trucks. In many cases, those individuals may tow trailers carrying equipment, material, or other mobile apparatuses. A traveler may tow such items for recreational or for business purposes. Safety is paramount for any traveler, especially for those who are towing valuable or dangerous material. For example, many enthusiasts may tow a motorcycle, an All-Terrain Vehicle (ATV), or other similar mobile apparatus on the back of a trailer. The enthusiast must take special precautions when traveling to avoid sudden shifts in momentum caused by unsafe road conditions. Sudden changes in momentum could cause the mobile apparatus to quickly project forward or backwards resulting in damage or personal injury. Standard ratchet straps do not provide the necessary stability to hold a mobile apparatus in place and limits access to enclosed trailers when in use. For example, a user may have challenges traversing an enclosed trailer if a mobile apparatus, such as a motorcycle is secured by ratchet straps, to the walls and floors of the enclosed trailer. In addition, unlike motorcycles or other mobile apparatus that has a clutch system for locking the wheels, there are mobile apparatus that does not have integrated wheel locking mechanism such as motorcycle trailers. If a traveler is towing a motorcycle and a motorcycle trailer, the motorcycle trailer has the potential of shifting forward or backwards in response to any sudden movements by the traveler. This sudden shift would cause damage to the motorcycle, the trailer, or the motorcycle trailer itself. The embodiments described herein provides an apparatus and method for restricting a mobile apparatus from shifting forward or backwards in response to any sudden movements by the traveler. In addition, the apparatus also eliminates the need for ratchet straps which would in result increase the space around the cabin of the trailer.

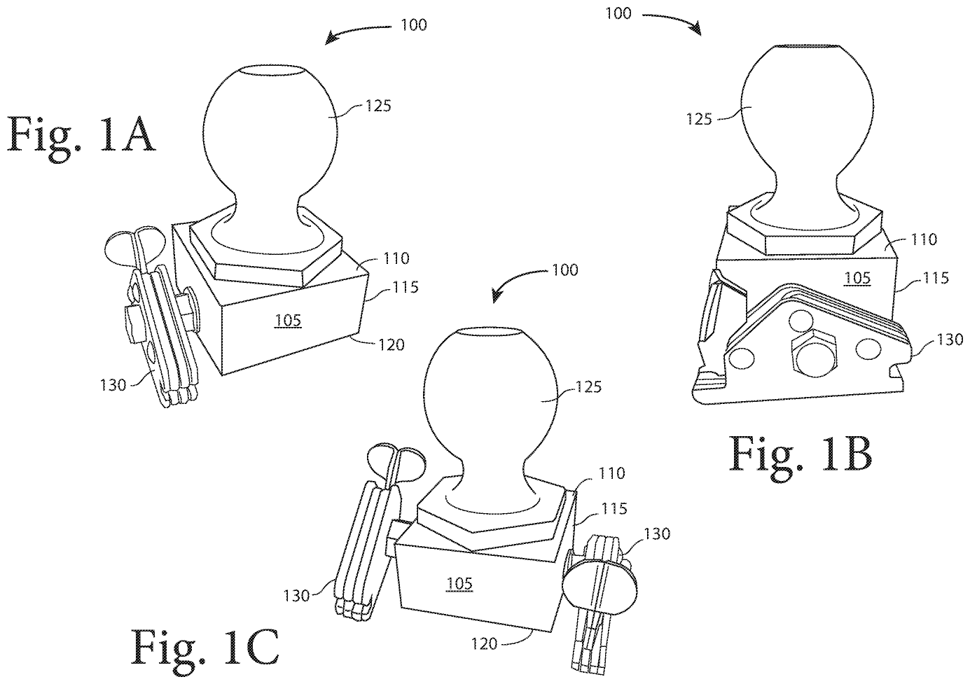

FIG. 1A is a perspective view of a hitch stabilizer. FIG. 1B is a front perspective view of a hitch stabilizer. FIG. 1C is a perspective view of a hitch stabilizer having two track tie downs. As illustrated in FIGS. 1A-1C, an apparatus for securing a mobile unit, such as a motorcycle trailer, to a trailer bed may include a hitch stabilizer 100. The hitch stabilizer 100 may include a base 105. The base 105 may be manufactured from a metal alloy or other similar material. In one or more embodiments, the base 105 may include a base head section 110, a base body section 115, and a base foot section 120. The base head section 110 is integrally coupled to the base body section 115. In addition, the base body section 115 is integrally coupled to the base foot section 120.

The hitch stabilizer 100 may also include a ball joint 125 coupled to the base 105. In one or more embodiments, the ball joint 125 is coupled to the base head section 110. The ball joint 125 may be integrally coupled to the base head section 110 using bonding methods, such as spot welding or other similar means. In one or more embodiment, the ball joint 125 may be made of the same or similar material as the base 105. The hitch stabilizer 100 may also include a track tie down 130 coupled to the base 105. In one or more embodiments, the track tie down 130 is coupled to the base body section 115. The track tie down 130 may be integrally coupled to the base body 115 section using bonding methods, such as spot welding or other similar means. The track tie down 130 may be made of the same or similar material as the base 105 and the ball joint 125. In one or more embodiments, as illustrated in FIG. 1C the hitch stabilizer 100 may have two track tie downs 130 coupled to the base 105.

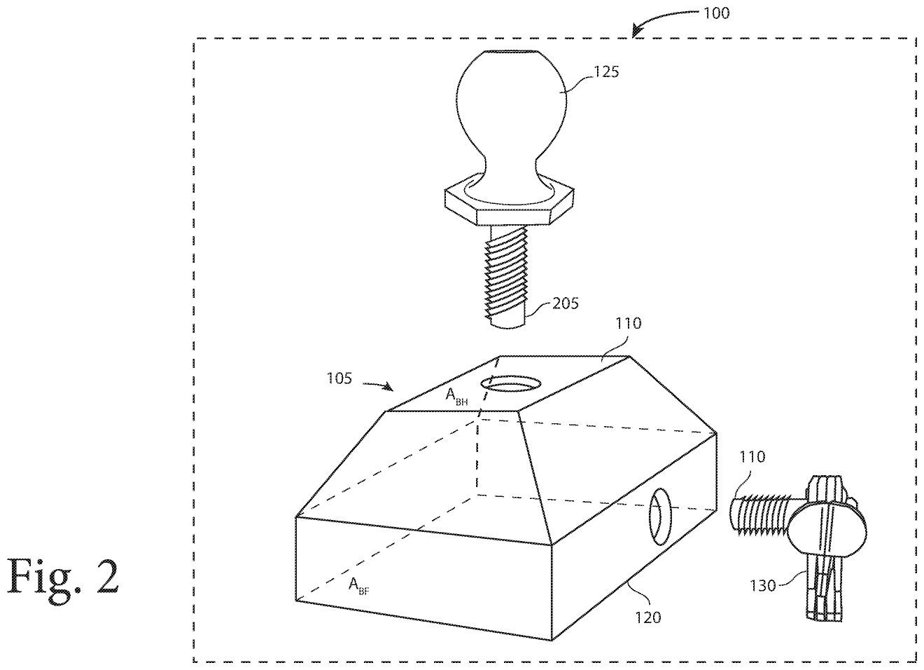

FIG. 2 is an exploded view of a hitch stabilizer having a pyramidal base. As illustrated in FIG. 2 the hitch stabilizer 100 includes the base 105, the ball joint 125 and the track tie down 130. In one or more embodiments, the ball joint 125 may be coupled to the base 125 using a screw 205 coupled to the ball joint 125. In this embodiment, a traveler (not shown) has the option, if required, of interchanging the ball joint 125 with another ball joint having a different diameter head, different shank length, or different shank rise. Further, the track tie down 130 may be coupled to the base body section 115 through a screw 210 coupled to the track tie down 130. Note, base 105 is depicted as translucent to illustrate the area of the base area foot, however, the holes in the base 105 that receive screw 205 and 210 are not depicted as translucent for clarity.

In one or more embodiments, as illustrated in FIG. 2, the base 105 may form a pyramidal shape. Alternatively, the base 105 may form a conical shape (not shown) or other similar shape such that the surface area of the base head section 110 is smaller than the surface area of the base foot section 120. For example, the base head section 110 may have a surface area A_{BH} that is smaller than the base foot section 120 surface area A_{BF}. In this embodiment, the pyramidal shaped base 105 absorbs the rotational force of the ball joint 125 caused by the stress applied by of the mobile unit (not shown) during movement. In one or more embodiments, the surface area A_{BH} of the base head section 110 is equal to the surface area A_{BF} of the base foot section.

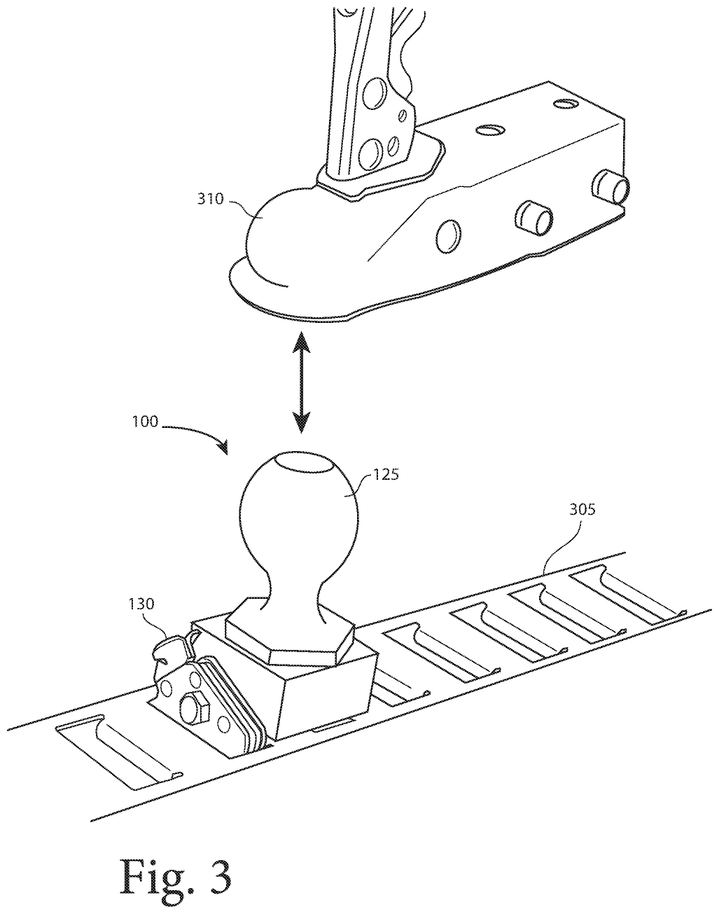

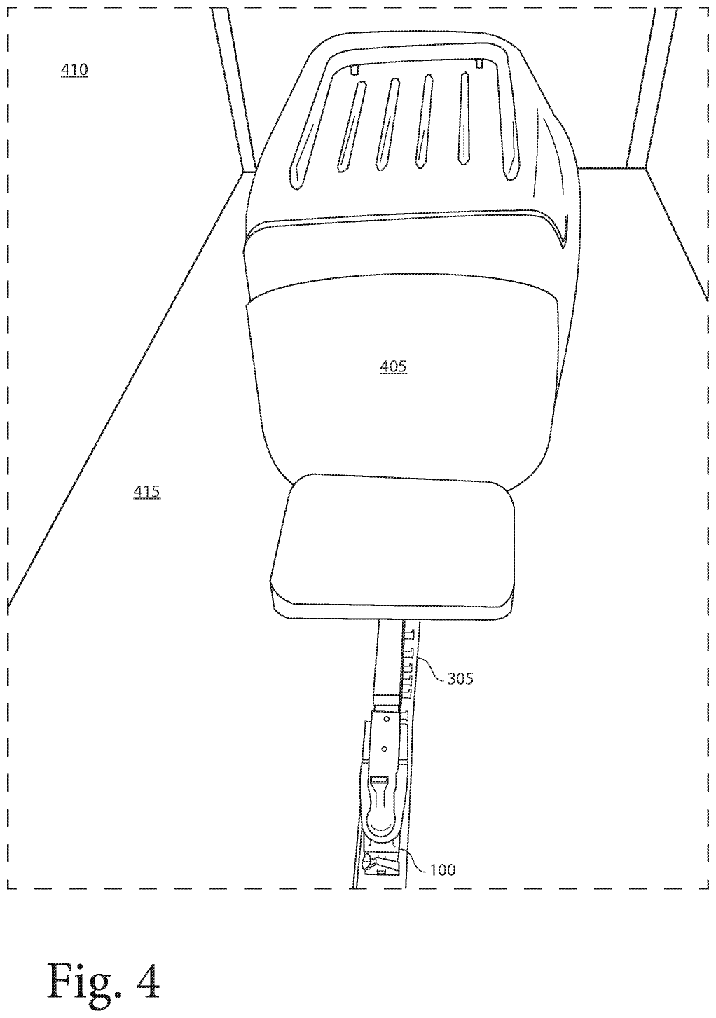

FIG. 3 is a perspective view of a trailer coupler and a hitch stabilizer coupled to a track rail. As illustrated in FIG. 3, the hitch stabilizer 100 is coupled to a track rail 305 using the track tie down 130. Once the hitch stabilizer 100 is secured to the track rail 305, the traveler (not shown) may couple a trailer coupler 310 to the ball joint 125. Although not shown in FIG. 3, but described in reference to FIG. 4, the trailer coupler 310 is coupled to a mobile apparatus, such as a motorcycle hitch or other similar apparatus.

FIG. 4 is an aerial perspective view of a mobile unit, hitch stabilizer, and a track rail coupled to a bed of a trailer. In many instances, haulers or trailers have limited maneuverable space once the trailer is loaded with equipment, such as a motorcycle trailer. The limited space is further restricted once ratchet straps, or other similar devices, are secured to the equipment on the trailer. For example, as illustrated in FIG. 4, a mobile unit 405 (illustrated as a motorcycle trailer) is positioned inside an enclosed towing trailer 410. If the mobile unit 405 were secured by ratchet straps, or other similar device, the area around the mobile unit would be inaccessible by the traveler. Implementing the hitch stabilizer removes the need for ratchet straps.

Further, as illustrated in FIG. 4, the towing trailer 405 has a floor bed 415. Coupled to the floor bed 410 is the track rail 305. Once the mobile unit 405 is coupled to the hitch stabilizing unit 100 forward and backward momentum is restricted.

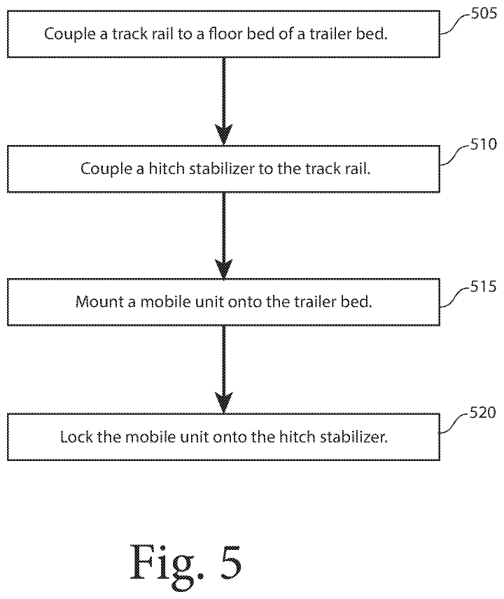

FIG. 5 is a flow chart of the method of coupling a mobile unit to a trailer using a hitch stabilizer. The method includes coupling a track rail (such as track rail 305) to a floor bed (such as floor bed 415) (block 505). Coupling a hitch stabilizer (such as hitch stabilizer 100) to the track rail (such as track rail 305) (block 510). Mounting a mobile unit (such as mobile unit 405) onto the trailer bed (such as floor bed 415) (block 515). Locking the mobile unit (such as mobile unit 405) onto the hitch stabilizer (such as hitch stabilizer) (block 520).

In one aspect, the apparatus includes a hitch stabilizer. The hitch stabilizer has a base having a base head section. The base head section has a base head area A_{BH}. The base has a body section and a base foot section. The base foot section has a base foot area A_{BF}. A ball joint is coupled to the base head section. A track tie down is coupled to the base body section.

Implementation may include one or more of the following. The ball joint may be integrally coupled to the base head section. The ball joint may be interchangeably coupled to the base head section. The track tie down may be bolted to the base body section. The area of the base head section may be less than the area of the base foot section. The area of the base head section may be equal to the area of the base foot section. The base, the ball joint, and the track tie down may be manufactured from a metal alloy.

In one aspect, the method includes coupling a track rail to a floor bed of a trailer. A hitch stabilizer is coupled to the track rail. The hitch stabilizer has a base having a base head section. The base head section has a base head area A_{BH}. The base has a body section and a base foot section. The base foot section has a base foot area A_{BF}. A ball joint is coupled to the base head section. A track tie down is coupled to the base body section. A mobile unit is mounted onto the trailer bed. The mobile unit is locked onto the hitch stabilizer wherein when the mobile unit is locked onto the hitch stabilizer forward and backward momentum is restricted.

Implementation may include one or more of the following. The ball joint may be integrally coupled to the base head section. The ball joint may be interchangeably coupled to the base head section. The track tie down may be bolted to the base body section. The area of the base head section may be less than the area of the base foot section. The area of the base head section may be equal to the area of the base foot section. The base, the ball joint, and the track tie down may be manufactured from a metal alloy.

In one aspect, the system includes a floor bed coupled to a trailer. A track rail is coupled to the floor bed. A hitch stabilizer is coupled to the track rail. The hitch stabilizer has a base having a base head section. The base head section has a base head area A_{BH}. The base has a body section and a base foot section. The base foot section has a base foot area A_{BF}. A ball joint is coupled to the base head section. A track tie down is coupled to the base body section. A mobile unit is mounted onto the trailer bed. The mobile unit is locked onto the hitch stabilizer wherein when the mobile unit is locked onto the hitch stabilizer forward and backward momentum is restricted.

Implementation may include one or more of the following. The ball joint may be integrally coupled to the base head section. The ball joint may be interchangeably coupled to the base head section. The track tie down may be bolted to the base body section. The area of the base head section may be less than the area of the base foot section. The area of the base head section may be equal to the area of the base foot section. The base, the ball joint, and the track tie down may be manufactured from a metal alloy.

The operations of the flow diagrams are described with references to the systems/apparatus shown in the block diagrams. However, it should be understood that the operations of the flow diagrams could be performed by embodiments of systems and apparatus other than those discussed with reference to the block diagrams, and embodiments discussed with reference to the systems/apparatus could perform operations different than those discussed with reference to the flow diagrams.

The word “coupled” herein means a direct connection or an indirect connection.

The text above describes one or more specific embodiments of a broader invention. The invention also is carried out in a variety of alternate embodiments and thus is not limited to those described here. The foregoing description of an embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. An apparatus for securing a mobile unit to a trailer comprising:
a hitch stabilizer, the hitch stabilizer having:
a base having:
a base head section having a base head area A_{BH},
a base body section, and
a base foot section having a base foot area A_{BF};
a ball joint coupled to the base head section; and
a track tie down coupled to the base body section.

2. The apparatus of claim 1 wherein the ball joint is integrally coupled to the base head section.

3. The apparatus of claim 1 wherein the ball joint is interchangeably coupled to the base head section.

4. The apparatus of claim 1 wherein the track tie down is bolted to the base body section.

5. The apparatus of claim 1 wherein the A_{BH} is less than A_{BF}.

6. The apparatus of claim 1 wherein A_{BH} equals A_{BF}.

7. The apparatus of claim 1 wherein the base, the ball joint, and the track tie down are manufactured from a metal alloy.

8. A method of securing a mobile unit to a trailer comprising:
coupling a track rail to a floor bed of the trailer;
coupling a hitch stabilizer to the track rail, the hitch stabilizer having:
a base having:
a base head section having a base head area A_{BH},
a base body section, and
a base foot section having a base foot area A_{BF};
a ball joint coupled to the base head section; and
a track tie down coupled to the base body section;
mounting a mobile unit onto the trailer bed; and
locking the mobile unit onto the hitch stabilizer;
wherein when the mobile unit is locked onto the hitch stabilizer forward and backward momentum is restricted.

9. The method of claim 8 wherein the ball joint is integrally coupled to the base head section.

10. The method of claim 8 wherein the ball joint is interchangeably coupled to the base head section.

11. The method of claim 8 wherein the track tie down is bolted to the base body section.

12. The method of claim 8 wherein the A_{BH} is less than A_{BF}.

13. The method of claim 8 wherein A_{BH} equals A_{BF}.

14. The method of claim 8 wherein the base, the ball joint, and the track tie down are manufactured from a metal alloy.

15. A system for securing a mobile unit to a trailer comprising:
a floor bed coupled to the trailer;
a track rail coupled to the floor bed;
a hitch stabilizer coupled to the track rail, the hitch stabilizer having:
a base having:
a base head section having a base head area A_{BH},
a base body section, and
a base foot section having a base foot area A_{BF};
a ball joint coupled to the base head section; and
a track tie down coupled to the base body section;
wherein when a mobile unit is locked onto the hitch stabilizer forward and backward momentum is restricted.

16. The system of claim 15 wherein the ball joint is integrally coupled to the base head section.

17. The system of claim 15 wherein the ball joint is interchangeably coupled to the base head section.

18. The system of claim 15 wherein the track tie down is bolted to the base body section.

19. The system of claim 15 wherein the A_{BH} is less than A_{BF}.

20. The system of claim 15 wherein A_{BH} equals A_{BF}.
